(19) United States
(12) Patent Application Publication
(10) Pub. No.: US 2008/0043309 A1
(43) Pub. Date: Feb. 21, 2008

(54) MICRO-DEVICE AND ELECTRODE FORMING METHOD FOR THE SAME

(75) Inventors: Tomohiko EDURA, Miyagi (JP); Jun MIZUNO, Tokyo (JP)

Correspondence Address: GREENBLUM & BERNSTEIN, P.L.C., 1950 ROLAND CLARKE PLACE, RESTON, VA, 20191, US

(73) Assignees: WASEDA UNIVERSITY, Tokyo (JP); PENTAX CORPORATION, Tokyo (JP)

(21) Appl. No.: 11/734,000

(22) Filed: Apr. 11, 2007

(30) Foreign Application Priority Data
Apr. 13, 2006 (JP) 2006-110893

(51) Int. Cl. G02B 26/08; B05D 5/12

(52) U.S. Cl. 359/223; 427/123

(57) ABSTRACT

An electrostatically driven micro-device includes a base substrate configured to have an electrically insulated surface, a rotatable electrode configured to be rotatable with respect to the base substrate, at least one recessed area configured to be recessed by a predetermined depth from surface of the base substrate, and a fixed electrode formed with a predetermined thickness on each of the at least one recessed area, the fixed electrode being located close to the rotatable electrode so as to generate an electrostatic attractive force between the fixed electrode and the rotatable electrode when a voltage is applied therebetween. The predetermined thickness of the fixed electrode is thinner than the predetermined depth of the at least one recessed area. A rotatable angle range of the rotatable electrode is restricted by the surface of the base substrate.

### BACKGROUND OF THE INVENTION

The present invention relates to an electrostatically driven micro-device and an electrode forming method, which can be employed when fabricating the micro-device, to form electrodes each of which generates an electrostatic attractive force between itself and a rotatable electrode configured to be rotatable with respect to a base substrate.

Recently, along with the development of a MEMS (Micro Electro Mechanical Systems) technology, various micro-devices has been developed and put into practical use. For example, there is cited as one of such micro-devices a micromirror as described in U.S. Pat. No. 6,431,714 (hereinafter, referred to as '714 patent) or U. Hofmann, S. Muehlmann, M. Witt, K. Dorschel, R. Schutz, and B. Wagner, “Electrostatically driven micromirrors for a miniaturized confocal laser scanning microscope”, in Proceedings of SPIE, vol. 3878, September 1999, pp. 29-38 (hereinafter, referred to as Hofmann's Publication). For instance, the micromirror device is utilized as an optical scanner and implemented in various devices such as a barcode reader and laser printer. It is noted that each of the micromirrors, described in '714 patent and Hofmann's Publication, is a so-called electrostatically driven micromirror configured such that a mirror is slightly tilted by an electrostatic attractive force generated between electrodes that face each other.

According to each of the micromirrors described in '714 patent and Hofmann's Publication, a reflective mirror is supported by a pair of torsion bars to be rotatable with respect to a base substrate. A pair of electrodes is symmetrically formed with respect to the center of the reflective mirror on an opposite surface of a reflective surface of the reflective mirror. Further, a plurality of fixed electrodes are formed on the base substrate such that each of the electrodes is located to closely face a corresponding one of the electrodes formed on the reflective mirror.

When a voltage is applied between one of the electrodes on the reflective mirror and a corresponding one of the fixed electrodes that faces the electrode on the reflective mirror, the torsion bars are twisted by the electrostatic attractive force generated between the aforementioned electrodes that face each other. Thereby, the reflective mirror is tilted around an axis defined by the longitudinal direction of the torsion bars. Meanwhile, when a voltage is applied between the other electrode on the reflective mirror and a corresponding one of the fixed electrodes that faces the other electrode on the reflective mirror, the torsion bars are twisted in the opposite direction of the direction in the aforementioned case. Accordingly, the reflective mirror is tilted around the axis defined by the longitudinal direction of the torsion bars in the opposite direction of the direction in the aforementioned case. By switching an electrode to which a voltage is applied between both of the electrodes on the reflective mirror, the reflective mirror makes a swing motion.

However, the electrostatically driven micromirror as described above has a specific problem, i.e., a so-called “pull-in”. The “pull-in” represents an uncontrollable state into which the reflective mirror is put when the electrostatic attractive force generated between both of the electrodes that face each other is larger than a resilience of the torsion bars. The “pull-in” may result in (permanent) sticking between an electrode on the reflective mirror and a fixed electrode on the base substrate that have contacted with each other. Due to the aforementioned sticking, the reflective mirror cannot physically make a swing motion.

Meanwhile, even though an electrode on the reflective mirror contacts with a fixed electrode on the base substrate, the sticking may not be caused. However, when both of the electrodes contacts with each other, electrical short between them can be caused, and therefore, the micromirror can be put into an uncontrollable state.

Conventionally, in order to avoid the aforementioned troubles, for example, at least ones of the electrodes on the reflective mirror and the fixed electrodes on the base substrate have been coated with insulating films. In addition, each of the fixed electrodes has been formed outside an area on the base substrate with which the electrodes on the reflective mirror can contact. Thereby, even though an electrode on the reflective mirror contacts with the base substrate, the aforementioned troubles can be prevented since each of the fixed electrodes is located at a predetermined distance from the contact point.

However, when at least ones of the electrodes on the reflective mirror and the fixed electrodes on the base substrate are coated with the insulating films, an insulating film coating process has to be added, it leads to undesirable results such as an increased manufacturing cost and a lengthened lead time. Further, when each of the fixed electrodes is formed outside an area on the base substrate with which the electrodes on the reflective mirror can contact, a base substrate of an appropriate size, which is large enough to attain the aforementioned relationship between the electrodes on the reflective mirror and the fixed electrodes on the base substrate, has to be prepared. Namely, the base substrate is required to have a larger size than the size of the reflective mirror. The micromirror is generally implemented in a limited space inside a device. Accordingly, factors that cause an increased micromirror size and inhibit reduction of the micromirror size are not desired.

### SUMMARY OF THE INVENTION

The present invention is advantageous in that there can be provided an improved micromirror that can prevent problems such as sticking and electrical short between an electrode on a reflective mirror and a fixed electrode on a base substrate that are caused by contact therebetween.

According to an aspect of the present invention, there is provided an electrostatically driven micro-device, which includes a base substrate configured to have an electrically insulated surface, a rotatable electrode configured to be rotatable with respect to the base substrate, at least one recessed area configured to be recessed by a predetermined depth from surface of the base substrate, and a fixed electrode formed with a predetermined thickness on each of the at least one recessed area, the fixed electrode being located close to the rotatable electrode so as to generate an electrostatic attractive force between the fixed electrode and the rotatable electrode when a voltage is applied therebetween. The predetermined thickness of the fixed electrode is thinner than the predetermined depth of the at least one recessed area. A rotatable angle range of the rotatable electrode is restricted by the surface of the base substrate.

Optionally, the rotatable angle range of the rotatable electrode may be restricted by contact of the rotatable electrode with the surface of the base substrate.

Optionally, the electrostatically driven micro-device may further include a pair of torsion bars connected with the rotatable electrode, the pair of torsion bars being configured to be twisted by the electrostatic attractive force generated between the fixed electrode and the rotatable electrode such that the rotatable electrode can rotate around a rotation axis defined by the pair of torsion bars, a gimbal portion configured to support the rotatable electrode via the pair of torsion bars, and a plurality of supporting portions provided between the gimbal portion and the base substrate so as to keep a predetermined gap between the rotatable electrode and the base substrate.

Still optionally, the rotatable electrode, the pair of torsion bars, and the gimbal portion may be integrally formed.

Further optionally, the rotatable electrode, the pair of torsion bars, the gimbal portion, and the plurality of supporting portions may be formed from an SOI wafer.

Optionally, the electrostatically driven micro-device may be a micromirror, and the rotatable electrode may be a reflective mirror including a reflective surface.

According to another aspect of the present invention, there is provided an electrode forming method for an electrostatically driven micro-device, which include steps of forming a photosensitive layer on a base substrate, exposing the photosensitive layer through a patterned mask to remove the photosensitive layer on at least one intended area of the base substrate, etching the at least one intended area of the base substrate by a predetermined depth so as to form at least one recessed area on the base substrate, forming a metal film with a predetermined thickness on an area including the at least one recessed area on the base substrate, and removing the photosensitive layer left on the base substrate.

Optionally, the predetermined thickness of the metal film may be thinner than the predetermined depth of the at least one recessed area.

According to a further aspect of the present invention, there is provided an electrostatically driven micro-device, which includes a base substrate configured to have an electrically insulated surface, a rotatable electrode configured to be rotatable with respect to the base substrate, at least one recessed area configured to be recessed by a predetermined depth from surface of the base substrate, and a fixed electrode formed with a predetermined thickness on each of the at least one recessed area, the fixed electrode being located close to the rotatable electrode so as to generate an electrostatic attractive force between the fixed electrode and the rotatable electrode when a voltage is applied therebetween. A rotatable angle range of the rotatable electrode is restricted by the surface of the base substrate. The fixed electrode on each of the at least one recessed area is formed by a method that includes steps of forming a photosensitive layer on the base substrate, exposing the photosensitive layer through a patterned mask to remove the photosensitive layer on at least one intended area of the base substrate, etching the at least one intended area of the base substrate by the predetermined depth so as to form the at least one recessed area on the base substrate; forming a metal film with the predetermined thickness on an area including the at least one recessed area on the base substrate, and removing the photosensitive layer left on the base substrate.

### BRIEF DESCRIPTION OF THE ACCOMPANYING DRAWINGS

FIG. 1 schematically shows a configuration of a micro mirror in an embodiment according to one or more aspects of the present invention.

FIG. 2 is a cross-sectional view of the micromirror in the embodiment according to one or more aspects of the present invention.

FIGS. 3A and 3B are cross-sectional views of the micromirror when a reflective mirror is tilted in different directions, respectively, in the embodiment according to one or more aspects of the present invention.

FIGS. 4A to 4E schematically show different steps in a process for forming fixed electrodes on a base substrate, respectively, in the embodiment according to one or more aspects of the present invention.

FIG. 5A is a perspective view of a fixed electrode and its adjoining area of the micromirror in the embodiment according to one or more aspects of the present invention.

FIG. 5B is a perspective view of a fixed electrode and its adjoining area of a micromirror in a second embodiment according to one or more aspects of the present invention.

### DETAILED DESCRIPTION OF THE EMBODIMENTS

Hereinafter, a micromirror in an embodiment according to the present invention will be described with reference to the accompanying drawings.

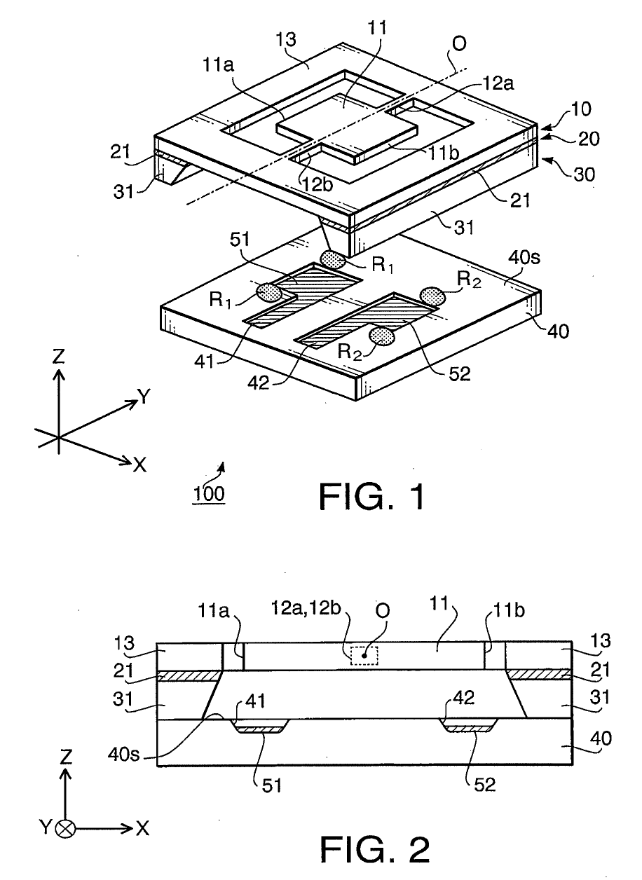

FIG. 1 is a perspective view schematically showing a configuration of a micromirror 100. The micro mirror 100 can be implemented in various devices such as a barcode reader and a laser printer, and is generally supported on a supporting substrate (not shown) inside the device. For the sake of descriptive convenience, axes X, Y, and Z perpendicular to each other are shown in each of FIGS. 1, 2, 3A, and 3B.

The micromirror 100 is fabricated in a process that includes a semiconductor process using a SOI (Silicon On Insulator) substrate. The SOI substrate is configured with a silicon oxide layer 20 being sandwiched between single-crystal silicon layers 10 and 30. Namely, the SOI substrate has a structure in which the semiconductor layers 10 and 30 are electrically isolated from one another by the insulating layer 20.

The micromirror 100 is provided with a reflective mirror 11, torsion bars 12a and 12b, gimbal portion 13, insulating layer 21, and two supporting portions 31. Each of the constituent elements is formed from the SOI substrate. Specifically, the reflective mirror 11, torsion bars 12a and 12b, and gimbal portion 13 are formed from the single crystal silicon layer 10. Meanwhile, the insulating layer 21 is formed from the silicon oxide layer 20. Further, the supporting portions 31 are formed from the single crystal layer 30.

A metal film is deposited on a surface of the reflective mirror 11 (which is an upper surface of the reflective mirror 11 in FIG. 1 and hereinafter, referred to as a reflective surface of the reflective mirror 11). There is incident onto the reflective surface of the reflective mirror 11 a beam for scanning an object to be scanned. The beam incident onto the reflective surface of the reflective mirror 11 is reflected in a predetermined direction. The predetermined direction, in which the beam reflected on the reflective surface of the reflective mirror 11 is directed, varies depending on the tilt angle of the reflective mirror 11. It is noted that, although the reflective mirror 11 is formed in a rectangular as shown in FIG. 1, the reflective mirror 11 of other shapes such as a circle and an oval can be applied.

The torsion bar 12a is formed to be protruded from a side surface of the reflective mirror 11 along the Y axis. Meanwhile, the torsion bar 12b is formed to be protruded from an opposite side surface of the aforementioned side surface of the reflective mirror 11 along the Y axis. The torsion bars 12a and 12b are relatively easy to be twisted when a moment of force around the torsion bars 12a and 12b is applied to the reflective mirror 11. When the torsion bars 12a and 12b are twisted, the reflective mirror 11 is tilted with respect to the gimbal portion 13. The tilt angle of the reflective mirror 11 is dependent on a torsion amount of the torsion bars 12a and 12b (in other words, dependent on an external force applied to the torsion bars 12a and 12b). The other end of each of the torsion bars 12a and 12b is integrally linked to the gimbal portion 13. It is noted that a reference sign “O” is added for a center axis of the torsion bars 12a and 12b for the sake of descriptive convenience.

The gimbal portion 13 is formed to cover an entire side surfaces of the reflective mirror 11. The reflective mirror 11 is supported by the torsion bars 12a and 12b to make a swing motion with respect to the gimbal portion 13.

The micromirror 100 is provided with a base substrate 40 formed from an insulating substrate such as a glass substrate. There are formed on a surface 40s of the base substrate 40 two recessed areas 41 and 42. On the recessed areas 41 and 42, fixed electrodes 51 and 52 are formed, respectively.

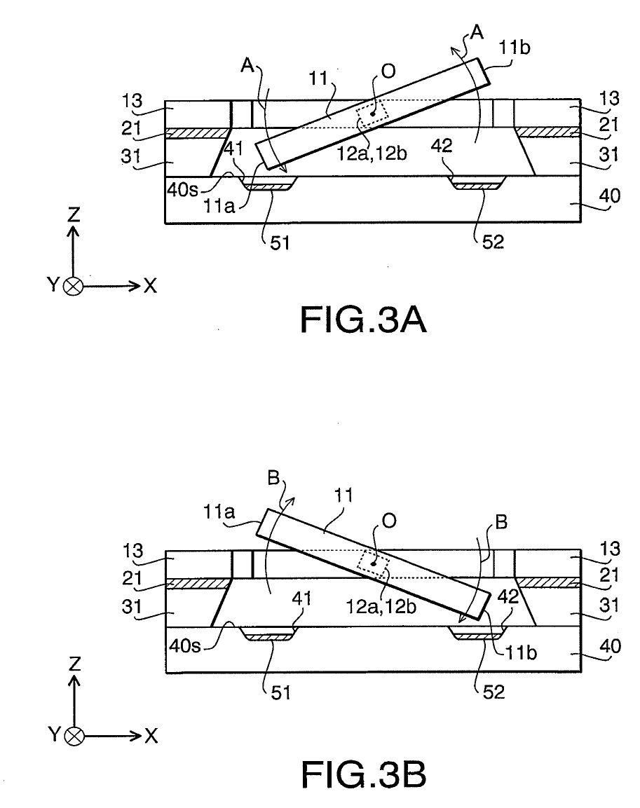

FIG. 2 is a cross-sectional view of the micromirror 100 in the embodiment according to the present invention, which is obtained by cutting the micromirror 100 along the X axis such that a section of the reflective mirror 11 is included in the cross-sectional view.

As shown in FIG. 2, the supporting portions 31 are placed and fixed on the base substrate 40. The supporting portions 31 are provided on the base substrate 40 such that a reverse surface of the reflective surface of the reflective mirror 11 (hereinafter, referred to as a reverse surface of the reflective mirror 11) is located to closely face the fixed electrodes 51 and 52. Particularly, the fixed electrode 51 is located to closely face a reverse surface portion in a vicinity of an end portion 11a of the reflective mirror 11. Meanwhile, the fixed electrode 52 is located to closely face a reverse surface portion in a vicinity of an end portion 11b of the reflective mirror 11. It is noted that the end portions 11a and 11b are in a symmetric relationship with respect to the center axis O.

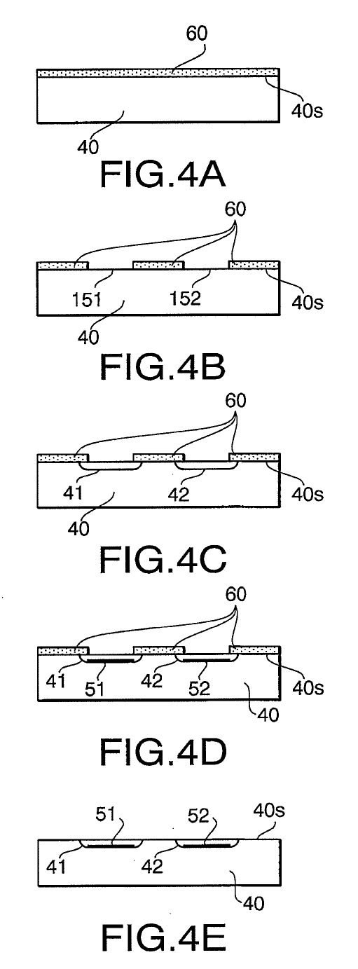

Subsequently, an operation of the micromirror 100 in the embodiment according to the present invention will be explained. FIG. 3A is a cross-sectional view of the micromirror 100 in the case where the reflective mirror 11 is tilted in a direction A. Meanwhile, FIG. 3B is a cross-sectional view of the micromirror 100 in the case where the reflective mirror 11 is tilted in a direction B.

The micromirror 100 is connected with a driver (not shown) that drives and controls the micromirror 100. Specifically, the micromirror is connected with the driver via a signal wire bonded with each of the gimbal portion 13 and the fixed electrodes 51 and 52. The micromirror 100 constitutes a circuit together with the driver.

For example, a predetermined voltage is applied between the reflective mirror 11 and the fixed electrode 51 by the diver to tilt the reflective mirror 11 in the direction A as shown in FIG. 3A. More specifically, for example, the predetermined voltage is applied such that the reflective mirror 11 (the entire single crystal silicon layer 10) and the fixed electrode 52 are connected to ground and the fixed electrode 51 is of a voltage V. Thereby, the electrostatic attractive force is generated between the reflective mirror 11 and the fixed electrode 51 such that the reflective mirror 11 is attracted by the fixed electrode 51. As aforementioned, the reflective mirror 11 is supported by the torsion bars 12a and 12b to be rotatable with respect to the gimbal portion 13. Accordingly, the torsion bars 12a and 12b are twisted when the reflective mirror 11 is attracted by the fixed electrode 51. At this time, the torsion bars 12a and 12b are substantially twisted around the center axis O, so that the reflective mirror can be rotated around the center axis O. Consequently, the reflective mirror 11 is tilted around the center axis O in the direction A in an X-Z plane.

In addition, for example, a predetermined voltage is applied between the reflective mirror 11 and the fixed electrode 52 by the driver to tilt the reflective mirror 11 in the direction B as shown in FIG. 3B. More specifically, for example, the predetermined voltage is applied such that the reflective mirror 11 (the entire single crystal silicon layer 10) and the fixed electrode 51 are connected to ground and the fixed electrode 51 is of a voltage V. Thereby, the electrostatic attractive force is generated between the reflective mirror 11 and the fixed electrode 52 such that the reflective mirror 11 is attracted by the fixed electrode 52. Accordingly, the torsion bars 12a and 12b are twisted when the reflective mirror 11 is attracted by the fixed electrode 52. At this time, the torsion bars 12a and 12b are substantially twisted around the center axis O, so that the reflective mirror 11 can be tilted around the center axis O in the direction B in the X-Z plane.

When the micromirror 100 is controlled by the driver, the reflective mirror 11 is tilted into a state where the electrostatic attractive force generated between the reflective mirror 11 and a corresponding one of the fixed electrodes 51 and 52 is identical to the resilience of the torsion bars 12a and 12b. For example, as the driving voltage to be applied by the driver is increased, the electrostatic attractive force is also increased, accompanied by the reflective mirror 11 being more tilted. According to a conventional micromirror, when a driving voltage higher than a predetermined critical voltage is applied to a micromirror 100, the “pull-in” is caused such that a reflective mirror 11 is so tilted as to contact with and stick to a fixed electrode.

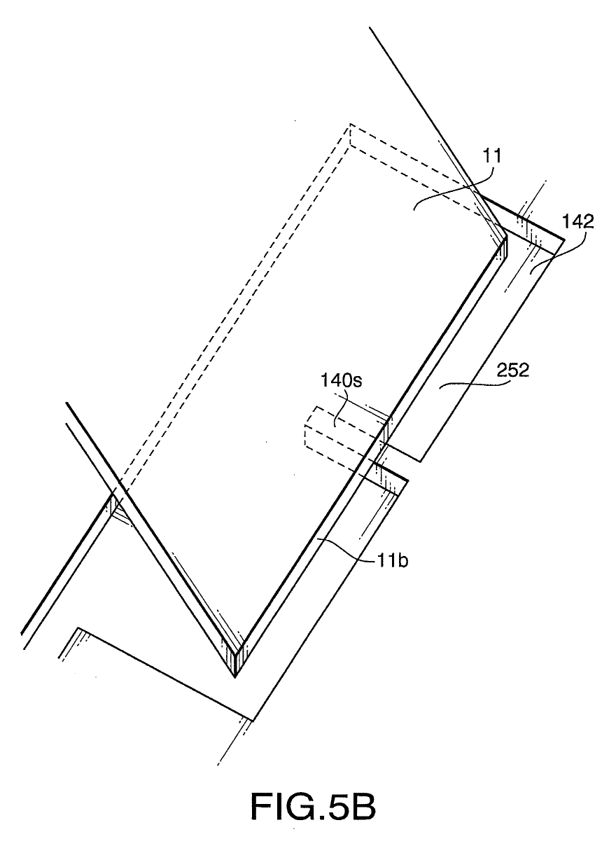

Even though the reflective mirror 11 is so tilted as to contact with the surface 40s of the base substrate 40, the micromirror 100 in the embodiment is configured such that the reflective mirror 11 cannot contact with the fixed electrode 51 or 52. Specifically, there are formed on the surface 40s of the base substrate 40 the recessed areas 41 and 42 each of which is formed flag-shaped with an elongated first area (pole area) provided for wire bonding with the driver and a wide rectangle second area (flag area) configured shorter than the reflective mirror 11 in the Y axis direction. In addition, each of the recessed areas 41 and 42 is arranged such that both ends of the second area is within a width defined by both ends of the reflective mirror 11 in the Y axis direction. Further, each of the recessed areas 41 and 42 is formed to be recessed from the surface 40s of the base substrate 40. The fixed electrodes 51 and 52 are provided on the recessed areas 41 and 42, respectively. Therefore, even though the reflective mirror 11 is overly tilted, the reflective mirror 11 contacts with predetermined areas R1 (or R2) outside the recessed area 51 (or 52) on the surface 40s of the base substrate 40 without contact with the fixed electrode 41 (or 42), as shown in FIG. 5A. Thereby, it is possible to avoid sticking and electrical short between the reflective mirror 11 and the fixed electrode 51 or 52.

As aforementioned, even though a driving voltage higher than the predetermined critical voltage is applied to the micromirror 100, the electrical short between the reflective mirror 11 and the fixed electrode 51 or 52 can be prevented to attain an appropriate operation of the micromirror 100.

It is noted that a fixed electrode is, in a conventional micromirror, formed on a base substrate and an insulating layer is further formed on the fixed electrode to prevent the sticking and electrical short between a reflective mirror and the fixed electrode. The formation of the insulating layer leads to increased steps of a fabrication process and an increased thickness of the micromirror. In another conventional micromirror, a fixed electrode is formed outside a location where a reflective mirror can contact with a base substrate. Such a structure leads to an increased size of micromirror.

However, according to the aforementioned configuration in the embodiment, the fixed electrodes 51 and 52 are provided on the recessed areas 41 and 42 that are formed to be recessed from the surface 40s of the base substrate 40, respectively. Accordingly, the fixed electrodes 51 and 52 configured as above are effective to attain a downsized micromirror 100.

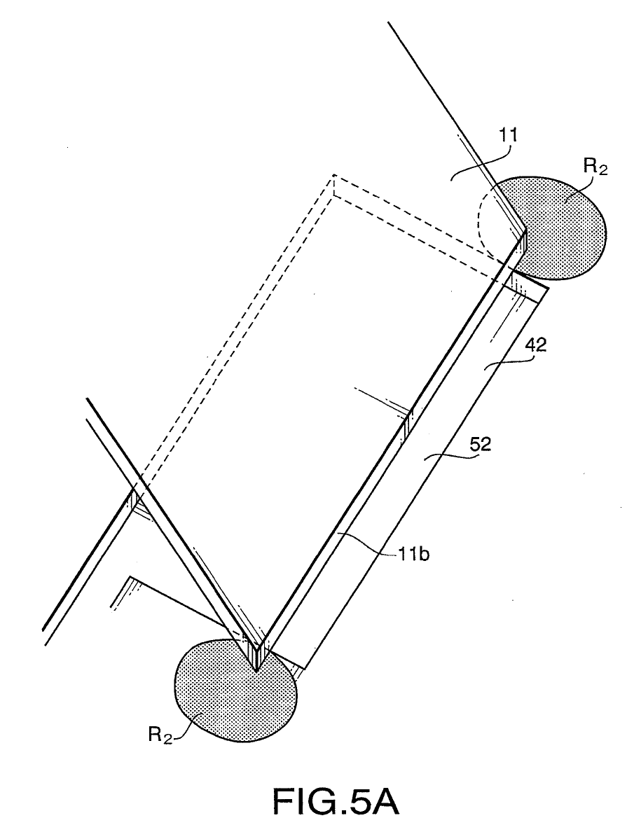

The fixed electrodes 51 and 52 are formed using a patterning process for electrode formation that is generally performed for fabricating a micromirror. Namely, a new step is not required for forming the fixed electrodes 51 and 52. FIGS. 4A to 4E schematically show steps of a process for forming the fixed electrodes 51 and 52. Hereinafter, the steps of the process for forming the fixed electrodes 51 and 52 will be explained with reference to FIGS. 4A to 4E.

In the process, firstly, photoresist 60 is applied on a glass substrate (i.e., on the surface 40s of the base substrate 40), for example, with a spin coating method (see FIG. 4A). Subsequently, a patterning step is performed, for example, with a photolithography method to form patterns 151 and 152 that correspond to the fixed electrodes 51 and 52, respectively, on the base substrate 40 (see FIG. 4B). In this patterning step, the photoresist 60 is partially removed such that areas (patterns 151 and 152) on the surface 40s where the fixed electrodes 51 and 52 are to be formed are exposed. It is noted that the area on the surface 40s other than the patterns 151 and 152 is still covered with the photoresist 60 in this step.

Following the patterning step, an etching step is carried out, for example, using BHF (buffered hydrofluoric acid). In the etching step, the exposed areas on the base substrate 40 are etched in accordance with the patterns 151 and 152, for example, by a depth of about 1 to 2 μm (see FIG. 4C). Consequently, the exposed areas corresponding to the patterns 151 and 152 are recessed by about 1 to 2 μm from the other area on the surface 40s, so that the recessed areas 41 and 42 are formed.

After the etching step, a chromium film with a thickness of about 50 nm is formed on each of the recessed areas 41 and 42 and the photoresist 60 with EB (Electron Beam) deposition. Further, a gold film with a thickness of about 100 nm is formed on the chromium film (see FIG. 4D). The films formed on the recessed areas 41 and 42 constitute the fixed electrodes 51 and 52, respectively. It is noted that the film thickness of each of the fixed electrodes 51 and 52 is less than 200 nm, and that the depth of each of the recessed areas 41 and 42 is about 1 to 2 μm as described above. Therefore, each of the fixed electrodes 51 and 52 is lower than the surface 40s of the base substrate 40 on the Z axis.

Following the deposition of the chromium/gold film, the photoresist 60 on the surface 40s is removed, for example, with a lift-off method (see FIG. 4E). In this step, the photoresist 60 on the surface 40s is removed, accompanied by the chromium/gold film on the photoresist 60 being removed as well. Consequently, there are remained on the base substrate 40 only the chromium/gold film on the recessed areas 41 and 42, i.e., only the fixed electrodes 51 and 52.

After the aforementioned steps, the fixed electrodes 51 and 52 are formed in a position sufficiently lower than the surface 40s on the Z axis (namely, on the recessed areas 41 and 42). In the embodiment, by using the patterning process for the electrode formation, the fixed electrodes 51 and 52 can be formed lower than the surface 40s of the base substrate 40. Hence, according to the embodiment, the micromirror 100 capable of preventing the sticking and electrical short between the reflective mirror 11 and the fixed electrode 51 or 52 can be fabricated without adding a new fabrication step.

Hereinabove, the embodiment according to the present invention has been described. However, the present invention is not limited to the aforementioned embodiment. Various sorts of modifications may be possible as far as they are within a technical scope which does not extend beyond a subject matter of the present invention.

For example, in the embodiment, the uniaxial micromirror has been described, yet a biaxial micromirror as another embodiment may be possible. In addition, the shape, depth, and location of each of the recessed areas 41 and 42 on which the fixed electrodes 51 and 52 are formed, respectively, are adopted depending on various parameters such as the size, shape, desired tilt angle, and the number of scanning axes of the reflective mirror 11. It is noted that the shape and location of each of the recessed areas 41 and 42 can be changed, for example, by modifying a mask pattern in the patterning step. Additionally, the depth of each of the recessed areas can be changed by modifying a condition such as an etching time period in the etching step.

FIG. 5B is a perspective view of a fixed electrode and its adjoining area of a micromirror in a second embodiment. In the second embodiment, a recessed area 142 is formed in a shape of “U”, that is, a partially notched rectangle. A protruded portion 140s shown in FIG. 5B that corresponds to the partially notched portion of the recessed area 142 is a portion of the surface 40s of the base substrate 40, and is shaped rectangular. A fixed electrode 252 is formed in accordance with the shape of the recessed area 142. In addition, the other recessed area (not shown) and fixed electrode (not shown) are formed in the same manner.

According to the second embodiment, the protruded portion 140s is formed to protrude from the adjoining area (the surface 40s) of the recessed area 142 toward an inside of the recessed area 142. Further, the protruded portion 140s is located so as to contact with the end portion 11b of the reflective mirror 11 when the reflective mirror 11 is excessively tilted and keep the reflective mirror 11 from contacting with the fixed electrode 252. Therefore, the aforementioned troubles such as the sticking and electrical short between the reflective mirror 11 and the fixed electrode 252 can be prevented.

Furthermore, according to the second embodiment, the fixed electrode 252 can be formed to be wider than the reflective mirror 11 in the Y axis direction. In other words, the fixed electrode 252 that faces the reflective mirror 11 can be configured to have a relatively wide area. Therefore, it is possible to generate an electrostatic force required for driving the micromirror 100 by a relatively low voltage.

The present disclosure relates to the subject matter contained in Japanese Patent Application No. P2006-110893, filed on Apr. 13, 2006, which is expressly incorporated herein by reference in its entirety.

What is claimed is:

1. An electrostatically driven micro-device, comprising:
a base substrate configured to have an electrically insulated surface;
a rotatable electrode configured to be rotatable with respect to the base substrate;
at least one recessed area configured to be recessed by a predetermined depth from surface of the base substrate; and
a fixed electrode formed with a predetermined thickness on each of the at least one recessed area, the fixed electrode being located close to the rotatable electrode so as to generate an electrostatic attractive force between the fixed electrode and the rotatable electrode when a voltage is applied therebetween, the predetermined thickness of the fixed electrode being thinner than the predetermined depth of the at least one recessed area, and
wherein a rotatable angle range of the rotatable electrode is restricted by the surface of the base substrate.

2. The electrostatically driven micro-device according to claim 1,
wherein the rotatable angle range of the rotatable electrode is restricted by contact of the rotatable electrode with the surface of the base substrate.

3. The electrostatically driven micro-device according to claim 1, further comprising:
a pair of torsion bars connected with the rotatable electrode, the pair of torsion bars being configured to be twisted by the electrostatic attractive force generated between the fixed electrode and the rotatable electrode such that the rotatable electrode can rotate around a rotation axis defined by the pair of torsion bars;
a gimbal portion configured to support the rotatable electrode via the pair of torsion bars; and
a plurality of supporting portions provided between the gimbal portion and the base substrate so as to keep a predetermined gap between the rotatable electrode and the base substrate.

4. The electrostatically driven micro-device according to claim 3,
wherein the rotatable electrode, the pair of torsion bars, and the gimbal portion are integrally formed.

5. The electrostatically driven micro-device according to claim 3,
wherein the rotatable electrode, the pair of torsion bars, the gimbal portion, and the plurality of supporting portions are formed from an SOI wafer.

6. The electrostatically driven micro-device according to claim 1,
wherein the electrostatically driven micro-device is a micromirror,
wherein the rotatable electrode is a reflective mirror including a reflective surface.

7. An electrode forming method for an electrostatically driven micro-device, comprising steps of:
forming a photosensitive layer on a base substrate;
exposing the photosensitive layer through a patterned mask to remove the photosensitive layer on at least one intended area of the base substrate;
etching the at least one intended area of the base substrate by a predetermined depth so as to form at least one recessed area on the base substrate;
forming a metal film with a predetermined thickness on an area including the at least one recessed area on the base substrate; and
removing the photosensitive layer left on the base substrate.

8. The electrode forming method according to claim 7,
wherein the predetermined thickness of the metal film is thinner than the predetermined depth of the at least one recessed area.

9. An electrostatically driven micro-device, comprising:
a base substrate configured to have an electrically insulated surface;
a rotatable electrode configured to be rotatable with respect to the base substrate;
at least one recessed area configured to be recessed by a predetermined depth from surface of the base substrate; and
a fixed electrode formed with a predetermined thickness on each of the at least one recessed area, the fixed electrode being located close to the rotatable electrode so as to generate an electrostatic attractive force between the fixed electrode and the rotatable electrode when a voltage is applied therebetween,
wherein a rotatable angle range of the rotatable electrode is restricted by the surface of the base substrate, and
wherein the fixed electrode on each of the at least one recessed area is formed by a method that includes steps of:
forming a photosensitive layer on the base substrate;
exposing the photosensitive layer through a patterned mask to remove the photosensitive layer on at least one intended area of the base substrate;
etching the at least one intended area of the base substrate by the predetermined depth so as to form the at least one recessed area on the base substrate;
forming a metal film with the predetermined thickness on an area including the at least one recessed area on the base substrate; and
removing the photosensitive layer left on the base substrate.

10. The electrostatically driven micro-device according to claim 9,
wherein the predetermined thickness of the metal film is thinner than the predetermined depth of the at least one recessed area.
